(19) United States
(12) Patent Application Publication
(10) Pub. No.: US 2004/0222756 A1
(43) Pub. Date: Nov. 11, 2004

(54) Electric motor

(76) Inventor: William Martin Crookes, Suffolk (GB)

Correspondence Address: Thomas M Galgano, Galgano & Burke, Suite 135, 300 Rabro Drive, Hauppauge, NY, 11788, US

(21) Appl. No.: 10/482,592

(22) PCT Filed: Jul. 5, 2002
(86) PCT No.: PCT/GB02/03104

(30) Foreign Application Priority Data
Jul. 5, 2001 (GB) 0116423.5

(51) Int. Cl. H02P 7/00

(52) U.S. Cl. 318/138

(57) ABSTRACT

An electric motor has a stator and a roto. The stator (1) comprises an annular armature (5) having a plurality of poles (7) evenly spaced about the inner circumferential surface of the armature (5) and directed towards a central longitudinal axis defined by the rotor shaft. A pair of firing/accumulator circuits (14,16) are connected in common and in series with respective sets of coils wound about the stator poles. The circuits are switched into and out of contact with their respective coil sets according to the position of the rotor with respect to the stator via position sensing elements which operate switches in the accumulator circuits. In an alternative embodiment firing and accumulation is effected using commutators and electrolytic capacitors (EC_{P}, EC_{N}). The motor is adapted to retrieve breakdown energy of the magnetic fields to realise a more efficient motor.

### FIELD OF THE INVENTION

The present invention relates to an electric motor and more particularly to an electric motor adapted to utilise magnetic field breakdown energy.

### BACKGROUND OF THE INVENTION

It is known amongst those skilled in the art that motor efficiency is relatively low due to various losses such as friction and heat losses. Of particular note are the losses incurred during the generation of the magnetic field which is essential to the conversion of mechanical energy to electrical energy and visa versa. Energy which is stored in this field during operation of the motor is lost, substantially entirely, when magnetic field breakdown occurs.

It is well appreciated that when a coil is energised and a magnetic field established that, if the electric circuit energising the field is disrupted, the breakdown of the magnetic field releases electrical energy which can be retained.

It is an object of the present invention to seek to alleviate the disadvantages associated with the prior art and to provide an improved efficiency electric motor utilising magnetic field breakdown energy.

### SUMMARY OF THE INVENTION

Accordingly, the present invention provides an electric motor having a stator and a rotor, the stator comprising an armature having a plurality of poles evenly spaced within the armature and directed towards a central longitudinal axis, the rotor being mounted for rotation on said axis and adapted to generate a field system to interact with said poles, wherein the poles carry a first and second set of series-connected coils which are operatively connected to first and second firing/accumulator circuits respectively for the storage of energy generated by the breakdown of the magnetic field of the motor.

Preferably, the rotor is mounted on a central shaft which includes at least one surface adapted to activate switch means which brings the first and second set of coils into and out of circuit with accumulator means of said firing/accumulator circuits.

Advantageously, the accumulator means comprises a battery.

Optionally, the accumulator means comprises a capacitor.

Preferably, the capacitor is an electrolytic capacitor controlled by a silicon controlled rectifier (SCR).

In one arrangement the central shaft includes a commutator surface adapted to engage brush contacts to effect switching which brings the first and second coils into and out of circuit with accumulator means of said firing/accumulator circuits.

Optionally, the at least one surface comprises a cam and the switch means comprise microswitches directly actuable by the cam surface of the central shaft. Alternatively, the switch means comprises at least one triac gate triggered by a position sensor mounted on or adjacent the rotor or rotor shaft.

The switch means or microswitches, in parallel connection with diodes, dictate the timing and direction of breakdown current from the motor to the batteries and visa versa.

The pole mounted coils are wound alternately to form North and South magnetic poles. The firing/accumulator circuits include means for supplying direct current pulses or alternating current selectively to each set of coils.

### BRIEF DESCRIPTION OF THE DRAWINGS

The invention will now be described more particularly, with reference to the accompanying drawings which show, by way of example only, two embodiments of improved electric motor according to the invention. In the drawings:

FIG. 1 is a schematic end elevation of a first embodiment of motor having two sets of series connected coils mounted on stator poles and corresponding firing/accumulator circuits, the motor pulse phase being between 0 and 22.5°;

FIG. 2 is a schematic end elevation, similar to that of FIG. 1, where the motor pulse phase is between 22.5° and 45°;

FIG. 3 is a schematic end elevation, similar to that of FIG. 1, where the motor pulse phase is between 45° and 67.5°;

FIG. 4 is a schematic end elevation, similar to that of FIG. 1, where the motor pulse phase is between 67.5°and 90°;

FIG. 5 is a vertical cross section taken through the central longitudinal axis of the first embodiment of motor;

FIG. 6 is a schematic circuit diagram indicating current directions during accumulator input (firing) and magnetic field breakdown cycles;

FIGS. 7a to 7c are front, side and rear elevations of a first commutator in accordance with the second embodiment of motor, respectively;

FIGS. 8a to 8c are front, side and rear elevations of a second commutator of the second embodiment of motor, respectively;

FIG. 9 is a schematic circuit diagram illustrating the use of the first and second commutators and indicating current directions during firing and magnetic breakdown cycles; and

FIG. 10 is a schematic waveform diagram over 1 cycle or 45° rotation of the commutators of the second embodiment of the invention.

### DESCRIPTION OF THE PREFERRED EMBODIMENTS

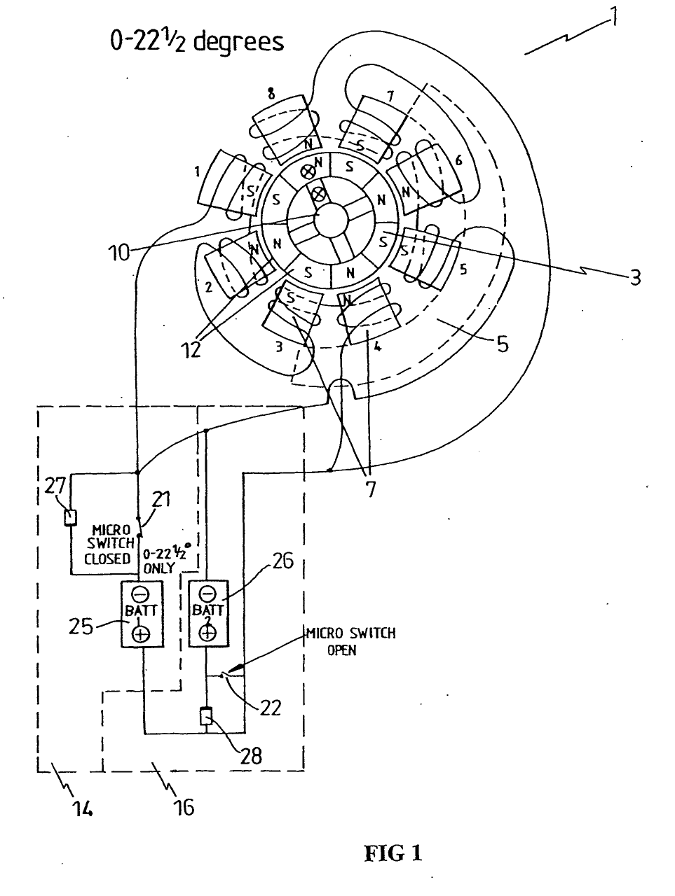

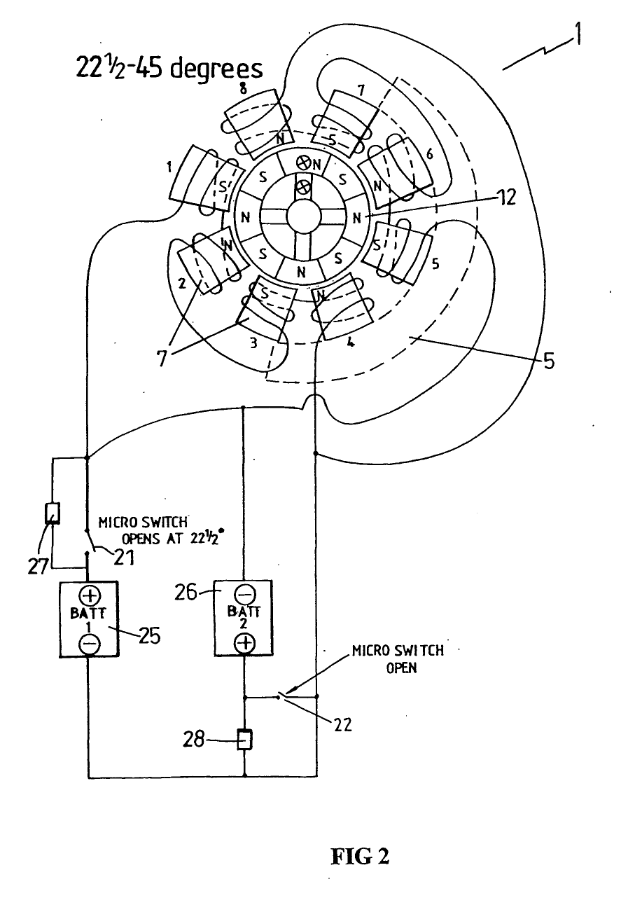

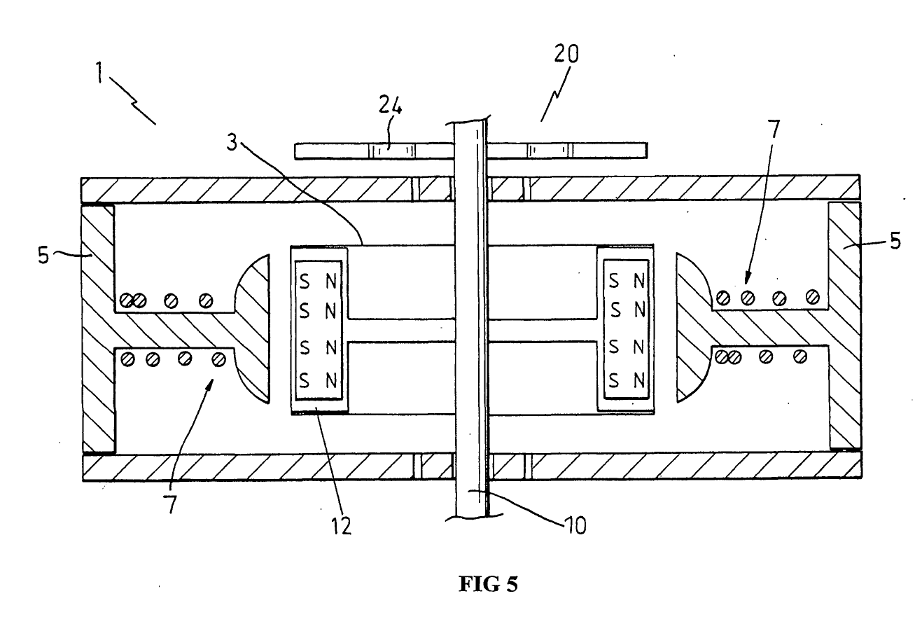

Referring to the drawings and initially to FIGS. 1 to 4, the motor has a stator 1 and a rotor 3. The stator 1 comprises an annular armature 5 (shown in dashed lines in FIGS. 1 and 2 and more clearly illustrated in FIG. 5) having a plurality of poles 7 evenly spaced about the inner circumferential surface of the armature 5 and directed towards a central longitudinal axis defined by a rotor shaft 10. The rotor 3 is mounted for rotation on the shaft 10 and has (by way of example and for clarity of illustration) eight permanent magnets 12 mounted thereon or embedded therein. The magnets which are positioned in a series of alternating polarity extend circumferentially about the rotor 3.

A pair of firing/accumulator circuits 14,16 are connected in common and in series with respective sets of coils wound about the poles 7 of the stator 5, the circuits 14,16 being switched into and out of contact with their respective coil sets according to the rotational position of the rotor 3 with respect to the stator 5. The switching is achieved by position sensing elements 20 which are operatively connected to switching elements 21,22 in the accumulator circuits 14,16.

In the illustrated embodiment, the switching elements comprise microswitches 21,22 operated by a cam surface 24 at one end of the rotor shaft 10, the cam surface 24 being profiled to activate the switches 21,22 according to a predetermined position or range of positions of the rotor 3.

The motor of the invention, hereinafter referred to as the “Ampere Torque Motor”, harnesses magnetic torque proportional to Ampere Turns to produce energy E in accordance with the formula:

E 32ωT

where ω=angular speed in radians per second, and

T=Magnetic Torque or Magnetic field strength.

FIG. 5 is a vertical cross-section of the motor which illustrates the relationship of the stator coils with the magnets mounted on the rotor 3. The stator 1 is held static by the motor body, including the armature 5. The rotor 3 is mounted for rotation on the rotor shaft 10 to which there is fixed the cam surface 24 for timed actuation of the microswitches 21,22.

The Ampere Torque Motor reclaims some of the electrical energy released when the magnetic field in the motor breaks down. Where a coil is energised and a magnetic field established, when subsequently the field is interrupted the breakdown of the magnetic field releases energy. The motor of the invention harnesses this energy.

To achieve this, a pair of batteries 25,26 are connected to a respective set of coils wound about the stator poles. Also associated with the batteries 25,26 are diodes 27,28, parallel connected with the respective microswitches 21,22 to control current direction. By alternately pulsing current from one battery into the machine and retrieving breakdown energy in the other battery in timed sequence, a more efficient motor is realised.

With reference to FIG. 1, the machine or motor is pulsed from the first battery 25 in one direction (normally clockwise) for 22.5° (from a datum 0°) as governed by the shaft driven cam element operating the first microswitch 21. The motion is caused by magnetic repulsion between the rotor and the electromagnets via the magnetic field established by the pulse which is transmitted through the first microswitch 21 which is closed. The electromagnets about pole numbers 1, 3, 5 and 7 have a designated polarity South during this phase and similarly pole numbers 2, 4, 6 and 8 are North. The current pulse remains for 22.5° of rotation at which time the first microswitch 21 closes. The second accumulator circuit microswitch 22 remains open through this entire rotational phase.

It will of course be appreciated by the skilled reader that other timing arrangements and mechanisms can be used. For example, the microswitches may be substituted by triacs which are gate triggered by position sensors mounted on or adjacent the stator, rotor or rotor shaft.

With reference to FIG. 2, from the rotational position 22.5° to 45°, the first microswitch 21 opens and magnetic attraction ensures motion of the rotor continues, coil breakdown takes place providing charging current to the second battery 26. During this phase of the cycle no power is provided from the batteries 25,26 however, the field breakdown retains pole numbers 1, 3, 5 and 7 at polarity South and pole numbers 2, 4, 6 and 8 are North. The magnetic field breakdown occurring during this phase converts back to electrical energy (incurring expected losses) which provides recharging current to the second battery 26 through the accompanying diode 28, bypassing the associated microswitch 22.

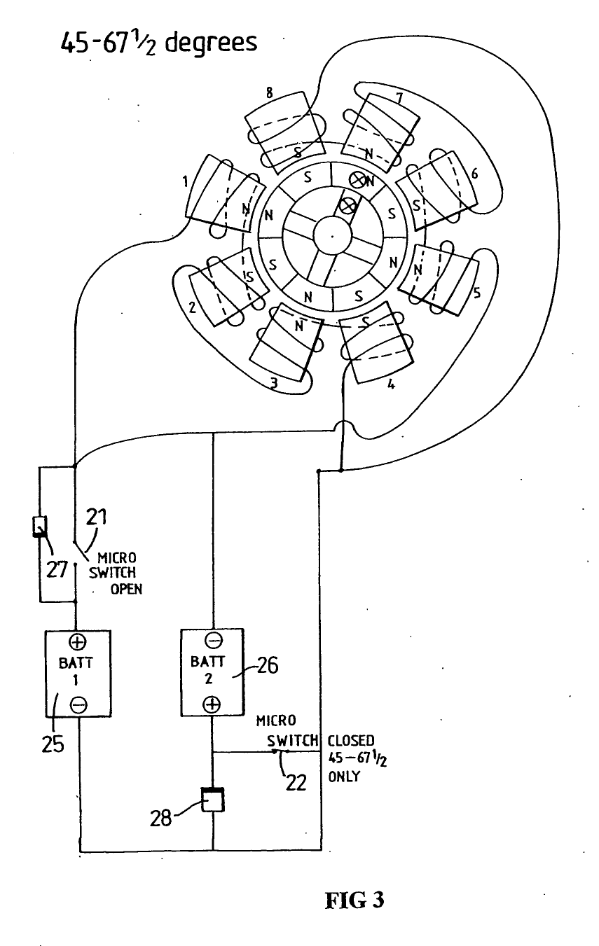

As illustrated in FIG. 3, from the rotational position 45° to 67.5°, the second microswitch 22 is closed and the machine is pulsed from the second battery 26 into motion by magnetic repulsive forces generated by the electromagnets which have North and South polarities on poles 1, 3, 5 and 7 and 2, 4, 6 and 8 respectively, that is, oppositely directed to the polarities established in the initial cycle phase, as described hereinabove with reference to FIG. 1. At the end of this third rotational phase, the second microswitch 22 opens again.

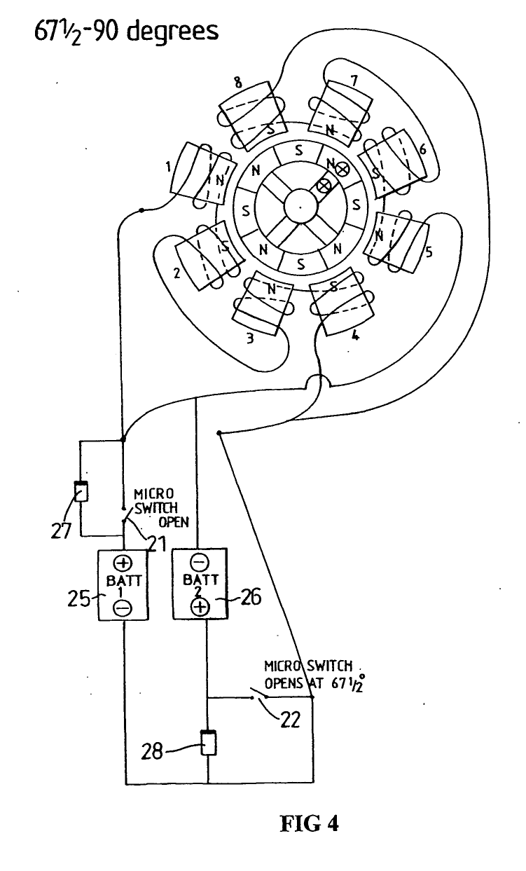

In the fourth rotational phase, occurring between 67.5° and 90°, as shown in FIG. 4, magnetic field breakdown of the coils takes place so as to recharge the first battery 25. As before, no power is provided to the machine but the attractive forces between the rotor magnets and the stator electromagnets, which have North and South polarities on poles 1, 3, 5 and 7 and 2, 4, 6 and 8, respectively, is such as to maintain motion. The magnetic field breakdown occurring during this phase converts back to electrical energy which is fed to the first battery 25 as recharging current through the accompanying diode 27, by-passing the open microswitch 21.

The four phases of the cycle are completed after 90° rotation of the rotor 3 with respect to the stator 1 and the cycle begins again as described with respect to FIG. 1. It will be readily appreciated that there are four cycles (each of four phases) for each machine revolution.

In the embodiment shown permanent magnets are provided on the rotor in four adjacent North and South pairs to correspond to the eight electromagnetic coils wound about the stator poles. Accordingly, there are eight input pulses per revolution and eight corresponding breakdown pulses per revolution, resulting in sixteen pulses (or phases) in all (16×22.5°=360°).

During the magnetic field breakdown pulse periods, no energy is taken from the batteries but energy is returned from the coils to the batteries.

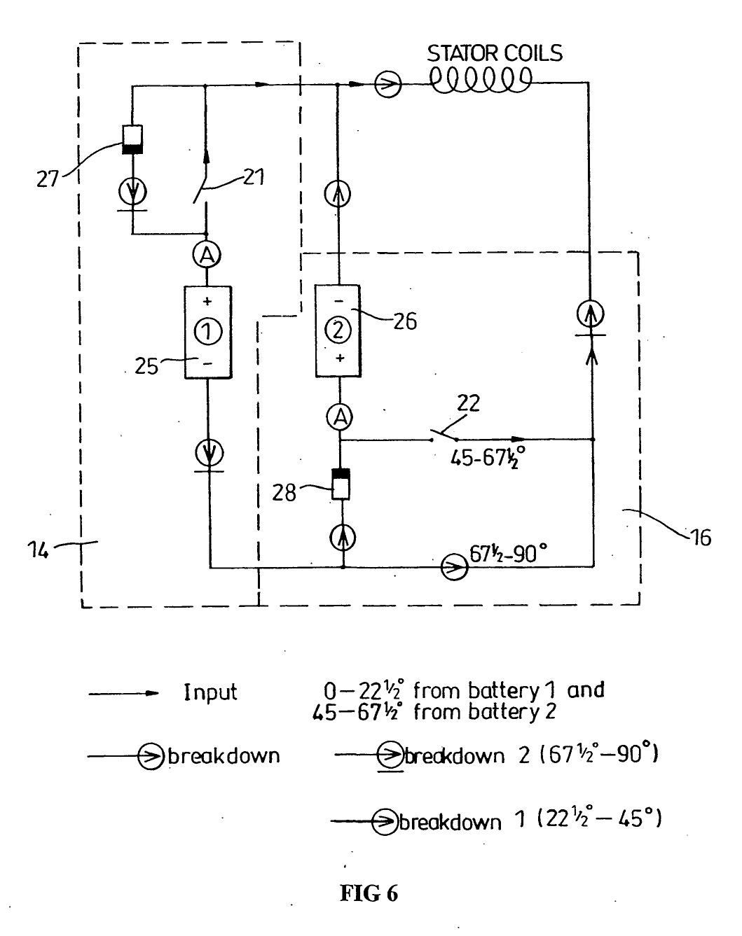

FIG. 6 also illustrates the current direction in the accumulator circuits during alternate “firing” and breakdown pulses/phases. When the machine is running at no load, the magnetic torque. between the electromagnets associated with the stator 1 and the permanent magnets 12 associated with the rotor 3, drives the machine at maximum speed. The battery ampere input is very low at no load as the magnetic torque is translated to top speed.

An ammeter A in the circuit, if set to read direct current will indicate the DC amps input. When set to read alternating current, the reading is twice the DC reading. However, as a battery only delivers direct current, the AC reading indicates that the batteries 25,26 are being recharged during the breakdown cycles. When the machine is loaded, work is done at the expense of speed. The DC amp input will increase as the machine is loaded and slows down but it will be noted that the AC readings remain twice those of the DC readings. This indicates that no matter what the DC input is, the same energy is returned at breakdown. The net battery energy input is therefore approaching zero.

It will be understood by the skilled reader that there remains a small I² R or heat loss. This loss can be relatively very small even when the machine is on load. The losses are reduced by utilising good coil design, that is using many turns to give high ampere turns or ampere torque and using a large coil diameter to give very low Ohm resistance.

Accordingly, when the machine operates on DC pulses, magnetic breakdown recharges each battery in turn between the pulses. As a result, net energy input even when the machine is on load is minimal. That input is reclaimed at breakdown apart from frictional and I² R (heat) losses. As before, work is done at the expense of speed.

The breakdown circuit resistance is only marginally higher than that of the coil because the internal resistance of the batteries is relatively small.

The electromagnetic coils are magnetically separated unlike in a conventional motor where they are all connected to a common core or yoke. As a result, in a conventional AC machine, the current is predominantly reactive and hence at low power factor at no load. When loaded the power factor increases but its breakdown value cannot be harnessed as it is all required to overcome the potential generating effect of the rotor before any work can be done. It is not essential that the coils are magnetically separated, however, in constructions where a complete magnetic yoke is provided, a higher back emf is developed and therefore a higher applied voltage becomes necessary.

In the present invention, with a DC battery input however, power factor is unity, that is, all the input is active and can be mostly reclaimed when the magnetic circuit collapses between the input pulses. Notably the loaded input requirement has already increased due to the mechanical load but is then reclaimed as breakdown recharges the batteries.

If the input from each battery is immediate, that is, the first battery charges for 45° then the second battery charges for the next 45°, the machine would not work. This is because the magnetic breakdown energy after each pulse would be fighting the immediate opposite direction input pulse, thus destroying the breakdown energy. This of course does not happen when the breakdown is not opposed but allowed to be utilised for recharging of the battery.

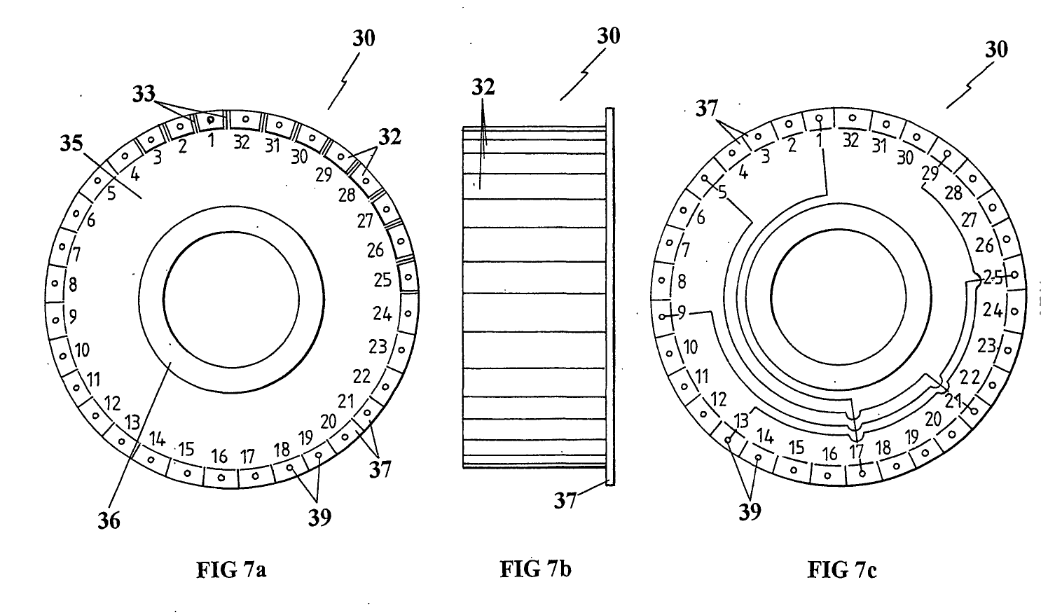

A second embodiment of motor will now be described with reference to FIGS. 7a to 10, in which the switching of firing/accumulator circuits is achieved by a pair of commutators. In the description that follows common reference numerals to those used in respect of the first embodiment will be retained for clarity.

FIGS. 7a to 7c illustrate a first commutator 30 which is provided with thirty-two commutator bars 32 each separated by mica insulation 33. The bars are mounted circumferentially on an insulator layer 35 which is formed about a steel core 36 which may include keys (not shown) for location on the rotor shaft 10. The insulator layer 35 usually comprises a mica composite. The commutator bars 32 include commutator risers 37 in which apertures 39 are formed to facilitate wiring and interconnections between the bars 32 to complete pulsed circuits.

As detailed in FIG. 7c, the first commutator 30 is wired for eight positive (+ve) pulses by connecting soldered copper wire connections between commutator bar risers 37 numbered as follows: 1 connects to 17; 5 connects to 21; 9 connects to 25; and 13 connects to 29. The even numbered bars are not electrically joined as in this embodiment, those connections correspond to “OFF” or “COIL BREAKDOWN” pulses. The eight +ve pulses are: 1-17; 5-21; 9-25; 13-29; 17-1; 21-5; 25-9; and 29-13.

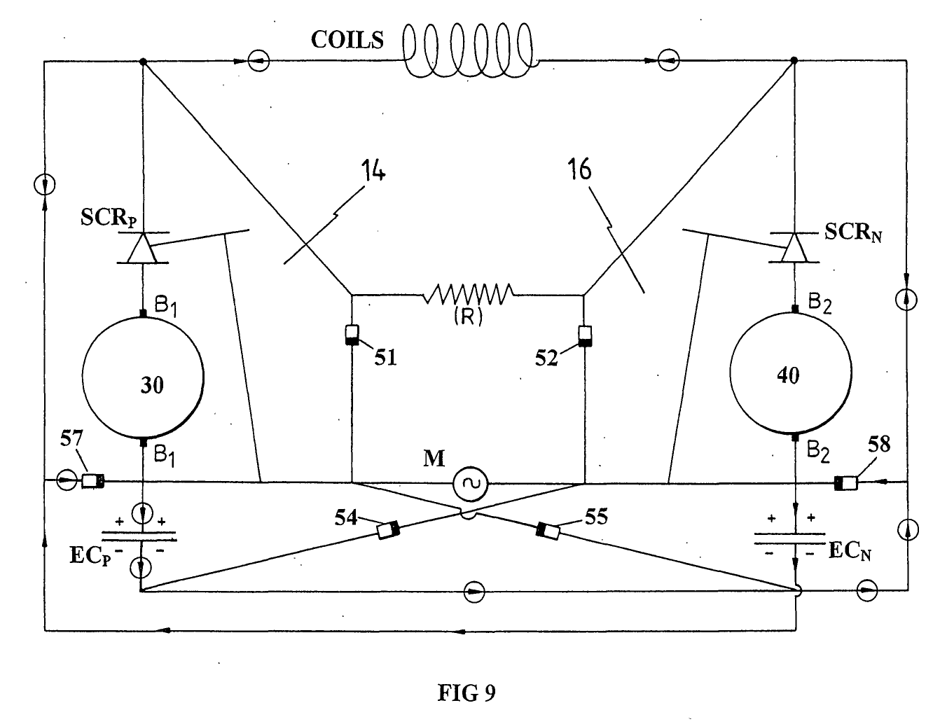

It will be noted or appreciated by the skilled addressee that the pulsed circuit is completed through the commutator from electrically connected, diametrically opposite commutator bars 32 during the “ON” pulses by means of a pair of brushes B or each commutator, as is shown in the schematic circuit diagram of FIG. 9. The brushes B need to be staggered slightly to ensure that a full 11.25° of pulse can take place, especially if the connecting surface width of the brushes is less than the width of the commutator bars 32. Where the effective connecting surface width of the brushes is identical to the width of the bars 32, the brushes need not be staggered and can be set at exactly 180° apart (leading edge to leading edge) without any offset, once the separation of the mica insulation 33 has been taken into account.

The “OFF” pulse which occur at coil breakdown are essentially bypassed by the commutator 30. Commutators are best bypassed at running (operational) speed, especially when the motor is loaded, that is, driving a mechanical load or alternator.

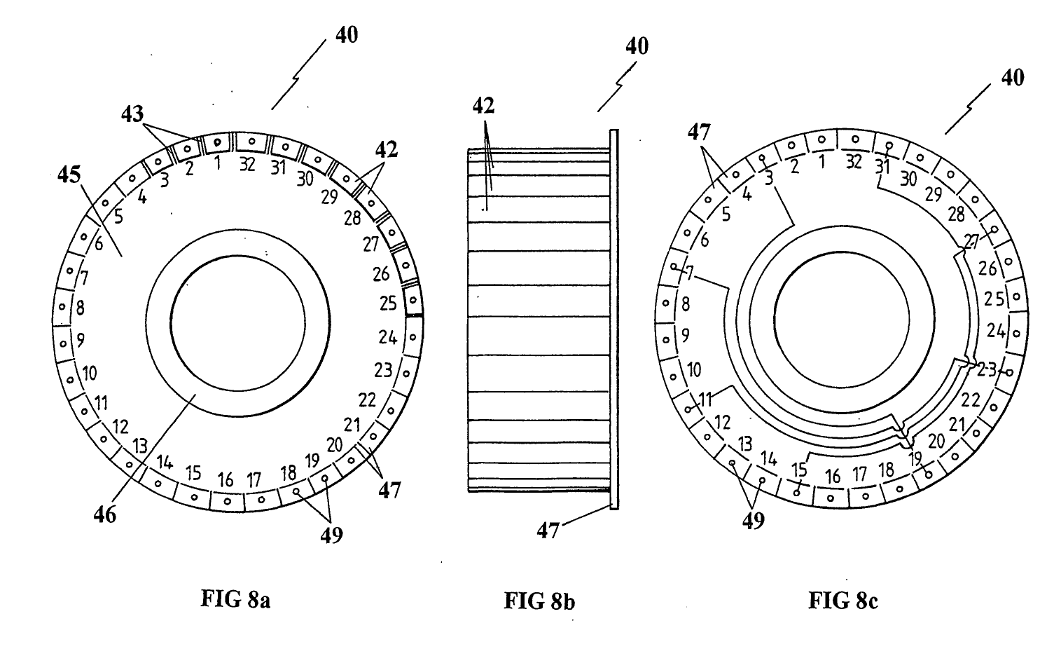

FIGS. 8a to 8c are illustrations substantially similar to those of FIGS. 7a to 7c but showing a second commutator 40 again provided with thirty-two commutator bars 42 each separated by mica insulation 43. An insulator layer 45 is formed about a steel core 46 which is correspondingly keyed to the rotor shaft 10 to ensure correct shaft positioning with respect to the first commutator 30. Commutator risers 47 include apertures 49 to facilitate wiring and interconnections between the bars 42.

The second commutator 40 is, wired for eight negative (−ve) pulses by interconnections between commutator bar risers 47 numbered as follows: 3 connects to 19; 7 connects to 23; 11 connects to 27; and 15 connects to 31. As before, the even numbered bars are not electrically joined as they correspond to “OFF” or “COIL BREAKDOWN” pulses. The eight −ve pulses are 3-19; 7-23; 11-27; 15-31; 19-3; 23-7; 27-11 ; and 31-15.

By utilising the +ve pulse commutator 30 and the −ve pulse commutator 40 together with electrolytic capacitors EC instead of microswitches and batteries, a second working embodiment of the invention is realised. One important distinction between the two embodiments is that a motor having permanent magnets in the rotor will normally need to be mechanically driven up to synchronous speed. With the commutator arrangement, with the appropriate number of commutator bars 32,42, this requirement is eliminated. This distinction is particularly relevant for large machines and more particularly for Ampere Torque motors.

It will be acknowledged by those skilled in the art that commutators may be designed to run up to speed any permanent magnet motor by using commutators with twice the number of bars than poles to allow for subsequent breakdown periods required with pulsing.

In this second embodiment of the invention, the mains waveform is used to trigger silicon controlled rectifiers SCRs which regulate energisation of the stator coils switched through the commutators 30,40. The motor comprises sixteen poles and is powered by input pulses triggered from the mains waveform. The motive power is accumulated in the electrolytic capacitors EC_{P}, EC_{N} and positive and negative pulses are passed through the positive and negative commutators 30,40, respectively into the coils and the pulsed circuit is coupled by returning to the negative terminals of the mains charged capacitors EC_{P}, EC_{N}. It is because the motor has sixteen poles and there are eight positive (+ve) and eight negative (−ve) “ON” pulses and a corresponding number of positive and negative “OFF” pulses of equal duration, that there is a total of thirty-two bars (corresponding to 11.25°) on each commutator 30,40.

The commutators act as ON/OFF switches and, no matter how slow the motor initially runs at start up, no incorrectly directed pulses are allowed to pass through the coils to impede or oppose the run up to operating speed. Thus, the commutator switching allows only “drive direction” pulses to pass to the coils.

The motor speed is ultimately determined by the number of poles provided and the mains cycling which in this case has been calculated on 60 cycle pulsing. For a 60 cycle, sixteen pole machine the speed will not exceed 450 rpm. It will be appreciated that because there are two “ON” pulses and two “OFF” (or coil breakdown) pulses each cycle, the SCRs must be clipped to 1/2 cycle or 11.25° for the motor to run at 450 rpm with the commutator bypassed. Bypassing the commutator when the motor is up to speed is optional but realisable.

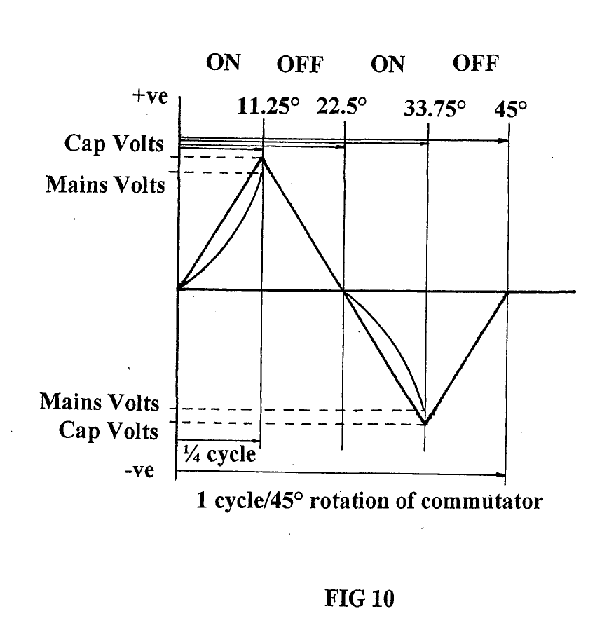

When the motor is run at 450 rpm there are eight mains cycles for each revolution of the commutator, that is 1 mains cycle is completed for only 45° rotation of the commutator, as illustrated and described in more detail hereinafter with respect to FIG. 10.

It will be seen that because the back emf of the rotor approaches but is less than the (voltage stored in the) mains charged capacitors, when the silicon controlled rectifiers SCR_{P}, SCR_{N} are fired, the resultant voltage across the coil is small but is sufficient to energise the electromagnetic coils during the 11.25° “ON” pulse. The energy put into the magnetic circuit is then allowed to breakdown during the subsequent 11.25° “OFF” pulse. This reclaimed energy charges the other capacitor EC, which when fired re-uses this energy to energise the coil in the other direction.

With reference again to FIG. 9, the schematic circuit diagram may be divided into a pair of firing/accumulator circuits 14,16 which as before are connected in common and in series with respective sets of coils wound about the poles 7 of the stator 5. The circuits 14,16 are switched into and out of contact with their respective coil sets according to the rotational position of the rotor 3 with respect to the stator. The switching is achieved by the position of the commutators 30,40 which are rotated on the rotor shaft 10 with respect to static commutator brushes B₁,B₂.

The mains supply M is operably coupled to the stator coils through the first commutator 30, which is configured as described hereinabove for +ve pulsing, and the second commutator 40, which is configured for −ve pulsing. The +ve pulsing is triggered through a positive pulse silicon controlled rectifier SCR_{P} and the −ve pulsing is triggered through a negative pulse silicon controlled rectifier SCR_{N}. As illustrated in the schematic circuit diagram of FIG. 10, the mains M is coupled in parallel, via mains blocking diodes 51,52, to a resistance R which represents the trigger resistance. This arrangement is also parallel coupled to the stator coils. Mains charging of the electrolytic capacitors EC_{P}, EC_{N}, which are coupled respectively to the first and second commutators 30,40, is through a pair of charging diodes 54,55 which are connected so as to retain the charges stored in the capacitors EC_{P}, EC_{N} until triggering of the corresponding silicon controlled rectifier SCR_{P}, SCR_{N} occurs. Breakdown charging diodes 57,58 are connected between the stator coils and the positive side of the electrolytic capacitors EC_{P}, EC_{N}. These diodes 57,58 may be omitted as required.

The breakdown voltage associated with the −ve pulse electrolytic capacitor EC_{N} passes through the coils and breakdown charging diode 58. Similarly, the negative to positive breakdown voltage associated with the +ve pulse electrolytic capacitor EC_{P} passes through the coils in the opposite direction and breakdown charging diode 57 as indicated by the circled arrows.

Finally with reference to FIG. 10, a waveform diagram is shown illustrating the anticipated combined waveform at running speed after the motor has “settled down”. The waveform is measured over 1 cycle or 45° of rotation of a commutator. In the first quater cycle, between 0-11.25°, the waveform comprises the discharge voltage of the +ve pulse electrolytic capacitor EC_{P} and mains. In the second quater cycle, between 11.25-22.5°, the waveform comprises the coil breakdown emf and the charging voltage required by the −ve pulse electrolytic capacitor EC_{N}. In the third quarter cycle, between 22.5-33.75°, the waveform comprises the discharge voltage of the −ve pulse capacitor EC_{N} and mains, and in the fourth quarter, between 33.75-45°, the waveform comprises the coil breakdown emf and the charging voltage required by the +ve pulse capacitor EC_{P}. In the fifth quarter (not shown), between 45-56.25°, the waveform repeats the waveform of the first quarter cycle (0-11.25°).

It will be seen that the mains voltage is zero at the start of the “ON” pulses and attain maximum value at cut-off, that is at the start of the “OFF” pulses. Furthermore, the capacitor maximum voltages (+ve and −ve) will exceed slightly the mains voltage by the addition of the coil breakdown (LI²). On breakdown the value of CV², which will equal the LI² value, is returned to the coils from the electrolytic capacitors when the magnetic field in the coils breaks down during the “OFF” pulse. The ampere turns value and hence torque (magnetic field strength in Tesla) is equal during each quarter cycle, although rising from zero to maximum and back to zero with the anticipated combined waveform of FIG. 10. Thus, over a full cycle, the breakdown coil energy=LI²/2 and the capacitor energy=CV²/2.

Mains also passes a small active current through the coils but, as the mains voltage is almost at every instant opposed by a substantially equal back emf curve caused by the rotor, the current value is, as stated above, small. However, because the electrolytic capacitors are kept at mains value, notionally via the charging and retaining diodes 54,55, if the mains voltage is above the rotor back emf, the machine will operate against this rotor emf opposing the applied mains voltage. The amount by which the mains voltage is in excess of the rotor back emf will determine the current in the electromagnetic coils. The Ampere Turns reacting with the permanent magnetic rotor therefore determines the torque of the machine.

As the sequence described with respect to FIG. 10 is continually recurring and the magnetic torque is continual through the “ON” and “OFF” pulses, the machine is highly efficient with a small input only required from the mains source over and above that required to overcome I²R and magnetic core losses. The power delivered by the machine is, as with conventional electric motors, speed times torque (ωT).

The essential feature of the second embodiment of the present invention is the substitution of batteries and microswitches for capacitors and at least one commutator (two commutators have been selected but it should be understood that the scope of the present invention does not preclude the realisation of an embodiment utilising a single commutator). Ordinarily, a motor having permanent magnets within the rotor requires to be mechanically driven up to synchronous speed. Using a commutator 30,40 with the appropriate number of commutator bars 32,42 eliminates this requirement which is significant when considering larger machines, particularly for an Ampere Turn motor.

It should be appreciated that the ampere torque motor is a prime energy source and can be used to drive

a) mechanical load at constant speeds, to replace conventional electric motors;

b) mechanical loads at variable speeds, for example motor vehicle engines;

and

c) electrical generators or alternators at constant or variable speeds and loading.

The ampere turn motor is capable of being used in practically any application where conventional electromagnetic machines are used.

It will be appreciated that as the machine is a prime energy source it may be utilised in environmentally efficient programmes and can efficiently utilise solar, wind or hydroelectric energy.

As will be appreciated by the skilled reader, the total number of stator magnets must always equal the number of rotor permanent magnets which may be substituted by DC electromagnets.

It will of course be understood that the invention is not limited to the specific details described herein, which are given by way of example only, and that various modifications and alterations are possible within the scope of the appended claims.

1. An electric motor having a stator (1) and a rotor (3), the stator (1) comprising an armature (5) having a plurality of poles (7) evenly spaced within the armature (5) and directed towards a central longitudinal axis, the rotor (3) being mounted for rotation on said axis and adapted to generate a field system to interact with said poles (7), wherein the poles (7) carry a first and second set of series-connected coils which are operatively connected to first and second firing/accumulator circuits (14,16) respectively for the storage of energy generated by the breakdown of the magnetic field of the motor.

2. An electric motor as claimed in claim 1, in which the rotor (3) is mounted on a central shaft (10) which includes at least one surface (24) adapted to activate switch means (21, 22) which brings the first and second set of coils into and out of circuit with accumulator means of said firing/accumulator circuits (14, 16).

3. An electric motor as claimed in claim 2, in which the accumulator means comprises a battery (25, 26).

4. An electric motor as claimed in claim 2, in which the accumulator means comprises a capacitor.

5. An electric motor as claimed in claim 4, in which the capacitor is an electrolytic capacitor regulated/controlled by a silicon controlled rectifier (SCR).

6. An electric motor as claimed in claim 2, in which the central (10) includes a commutator surface adapted to engage brush contacts to effect switching which brings the first and second coils into and out of circuit with accumulator means of said firing/accumulator circuits (14, 16).

7. An electric motor as claimed in claim 2, in which the at least one surface comprises a cam (24) and the switch means comprise microswitches (21, 22) directly actuable by the cam surface (24) of the central shaft (10).

8. An electric motor as claimed in claim 2, in which the switch means comprises at least one triac gate triggered by a position sensor (20) mounted on or adjacent the rotor (3) or rotor shaft (10).

9. An electric motor as claimed in claim 2, in which the switch means or microswitches (21, 22), in parallel connection with diodes (27, 28), dictate the timing and direction of breakdown current from the motor to the accumulator means and visa versa.

10. An electric motor as claimed in claim 1, in which the pole mounted coils are wound alternately to form North and South magnetic poles.

11. An electric motor as claimed in claim 1, in which the firing/accumulator circuits (14, 16) include means for supplying direct current pulses or alternating current selectively to each set of coils.

12. (Canceled)
